(19) United States
(12) Patent Application Publication
(10) Pub. No.: US 2006/0273846 A1
(43) Pub. Date: Dec. 7, 2006

(54) Bias voltage generator with auto trimming function

(75) Inventor: Seung-Won Lee, Seongnam-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/409,324

(22) Filed: Apr. 21, 2006

(30) Foreign Application Priority Data
Jun. 3, 2005 (KR) 2005-0047956

(51) Int. Cl. G05F 1/10

(52) U.S. Cl. 327/538

(57) ABSTRACT

An automatic trimming bias voltage generator that does not require a test mode to trim a bias voltage, and allows the bias voltage to be automatically trimmed in a plurality of operating voltage regions without adding elements to the layout. The automatic trimming bias voltage generator includes a reference bias voltage generation circuit generating a reference bias voltage; a bias voltage generation circuit, that generates a bias voltage which is automatically trimmed using the reference bias voltage as a reference voltage, a voltage comparing circuit, and a decoder. The voltage comparing circuit compares the reference bias voltage with a bias voltage output from a bias voltage generation circuit. The decoder receives and decodes a comparison signal from the voltage comparing circuit, and applies trimming information for the bias voltage obtained as the decoding result to the bias voltage generation circuit.

### CROSS-REFERENCE TO RELATED PATENT APPLICATIONS

This application claims priority to Korean Patent Application No. 2005-0047956, filed on Jun. 3, 2005, in the Korean Intellectual Property Office, the disclosure of which is incorporated herein in its entirety by reference.

### BACKGROUND OF THE INVENTION

1. Field of the Invention

The present invention relates to bias voltage generators, and more particularly, to bias voltage generators that do not require an additional test mode to trim a bias voltage and which allows the bias voltage to be automatically trimmed in a plurality of operating voltage regions without adding elements to the layout.

2. Description of the Related Art

A bias voltage generator, which is applied to a semiconductor integrated circuit or the like, receives an external supply voltage and generates a predetermined bias voltage. The bias voltage is used to maintain an operating voltage at a constant value in the semiconductor integrated circuit without respect to the external power supply voltage.

In general, bias voltage generators are divided into two different types: a stand-by bias voltage generator and an active-operation bias voltage generator. The stand-by bias voltage generator is optimized to minimize current consumption rather than to precisely and stably generate a voltage, whereas the active-operation bias voltage generator is optimized to precisely and stably generate a voltage rather than to minimize current consumption. Accordingly, although bias voltage generators have the same target voltage, a bias voltage output from the stand-by bias voltage generator is different from that output from the active-operation bias voltage generator. In particular, the difference between a bias voltage and a target voltage may be increased due to a change in an external supply voltage, temperature, or process conditions.

FIG. 1 is a block diagram illustrating the construction of a conventional bias voltage generator. As illustrated in FIG. 1, the conventional bias voltage generator may include a plurality of bias voltage generation circuits 1 through 3, and a multiplexer 4. The conventional bias voltage generator of FIG. 1 include m bias voltage generation circuits 1, 2, . . . , 3 that generate bias voltages of the same level.

If the first bias voltage generation circuit 1 is an active-operation bias voltage generator and the second and third bias voltage generation circuits 2 and 3 are stand-by bias voltage generators, one of the bias voltages output from the bias voltage generation circuits 1 through 3 is selectively output in response to a predetermined selection signal SEL<m:1> according to an operation mode. The multiplexer 4 is used to selectively output the bias voltages.

As described above, the characteristics of each bias voltage generation circuit vary according to a voltage, temperature, power consumption, and process conditions, and thus, bias voltages output from each bias voltage generation circuit are not the same. In general, bias voltages can be equalized with a target voltage by externally trimming the bias voltages using a test mode. A trimming technique of precisely adjusting a bias voltage is disclosed in US Patent Publication No. 2002-0153917.

To trim the bias voltages using the test mode, trimming information is generated to compensate for voltage differences, and the trimming information is stored in each bias voltage generation circuit. In general, a semiconductor integrated circuit using the bias voltages has operating voltage regions which are classified into, for example, a Class A region, a Class B region, and a Class C region according to an external voltage. The Class A region, the Class B region, and the Class C region have different trimming information.

However, when a bias voltage is trimmed using the test mode, a significant amount of time is required to perform the test mode to generate the trimming information. In particular, when a plurality of operating voltage regions are present, trimming information for all of the operating voltage regions must be generated, thereby greatly increasing the time for the test mode.

Also, after the test mode, a non-volatile storage device is required to maintain the trimming information stored in each bias voltage generation circuit. However, the non-volatile storage device stores information using a high voltage and thus requires an additional, separate high-voltage control circuit. Also, the capacity of the non-volatile storage device must be large enough to store the trimming information for all of a plurality of operating voltage regions.

### SUMMARY OF THE INVENTION

Exemplary embodiments of the invention include bias voltage generators that do not require an additional test mode to trim a bias voltage and allows the bias voltage to be automatically trimmed in a plurality of operating voltage regions without adding elements to the layout.

In one exemplary embodiment of the invention, there is provided an automatic trimming bias voltage generator which includes a reference bias voltage generation circuit, a bias voltage generation circuit, a voltage comparing circuit, and a decoder. The reference bias voltage generation circuit generates a reference bias voltage. The bias voltage generation circuit generates a bias voltage that is automatically trimmed using the reference bias voltage as a reference voltage. The voltage comparing circuit compares the reference bias voltage with a bias voltage output from the bias voltage generation circuit and outputs a comparison signal. The decoder receives the comparison signal from the voltage comparing circuit, decodes the comparison signal, and outputs the result of the decoding as trimming information for the bias voltage to the bias voltage generation circuit.

The bias voltage generation circuit may include a trimming information storage unit storing the trimming information for the bias voltage The trimming information storage unit may include volatile latches.

The voltage comparing circuit may include a first voltage divider, a second voltage divider and a comparator. The first voltage divider is for dividing the reference bias voltage. The second voltage divider is for dividing the bias voltage output from the bias voltage generation circuit. The comparator, which receives a voltage divided by the first voltage divider and a voltage divided by the second voltage divider, compares the received voltages, and outputs a comparison signal.

The voltage comparing circuit may further include a first enable switch and a second enable switch. The first enable switch is connected to the first voltage divider to prevent the divided reference bias voltage from being applied to the comparator after generation of the trimming information for the bias voltage. The second enable switch is connected to the second voltage divider to prevent the divided bias voltage from being applied to the comparator after the generation of the trimming information for the bias voltage.

According to another exemplary embodiment of the invention, there is provided an automatic trimming bias voltage generator which includes a reference bias voltage generation circuit, a plurality of bias voltage generation circuits, a voltage comparing circuit, and a decoder. The reference bias voltage generation circuit generates a reference voltage. The bias voltage generation circuits share the voltage comparing circuit. Each of the bias voltage generation circuits generate a voltage that is automatically trimmed using the reference bias voltage as a reference voltage. The voltage comparing circuit compares the reference bias voltage with a given bias voltage output from the respective bias voltage generation circuit, and outputs a comparison signal. The decoder receives the comparison signal, decodes the signal, and outputs the result of the decoding as trimming information for the bias voltage to a given bias voltage generation circuit.

According to another exemplary embodiment of the invention, there is provided an automatic trimming bias voltage generator which includes a reference bias voltage generation circuit, a plurality of bias voltage generation circuits, a plurality of voltage comparing circuits, and a plurality of decoders. The reference bias voltage generation circuit generates a reference voltage. The bias voltage generation circuits, each generate a bias voltage that is automatically trimmed using the reference bias voltage as a reference voltage. The voltage comparing circuits each compare the reference bias voltage with a bias voltage output from a corresponding bias voltage generation circuit. The decoders each receive and decode a comparison signal output from the corresponding voltage comparing circuit, and simultaneously provide trimming information obtained by decoding the comparison signals to the corresponding bias voltage generation circuit.

According to another exemplary embodiment of the invention, there is provided an automatic trimming bias voltage generator which includes a reference bias voltage generation circuit, a bias voltage generation circuit, a trimming information generation circuit, and a control logic. The reference bias voltage generation circuit generates a reference bias voltage. The bias voltage generation circuit generates a bias voltage that is automatically trimmed using the reference bias voltage as a reference voltage. The trimming information generation circuit receives the reference bias voltage and the bias voltage output from the bias voltage generation circuit, and generates trimming information for the bias voltage. The control logic generates a control signal containing information regarding a period when the bias voltage is trimmed due to a change in the bias voltage, and enables the trimming information generation circuit in the period.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a block diagram illustrating a conventional bias voltage generator;

FIG. 2 is a block diagram illustrating a bias voltage generator according to an exemplary embodiment of the invention;

FIG. 3 is a detailed circuit diagram illustrating an exemplary embodiment of a voltage comparing circuit, which can be implemented in the circuit of FIG. 2 according to an exemplary embodiment of the invention;

FIG. 4 is a block diagram illustrating a bias voltage generator in which a plurality of bias voltage generation circuits are connected to a voltage comparing circuit and a decoder, according to another exemplary embodiment of the invention;

FIG. 5 is a block diagram illustrating a bias voltage generator according to another exemplary embodiment of the invention;

FIG. 6 is a block diagram illustrating a bias voltage generator according to another exemplary embodiment of the invention; and

FIG. 7 is an exemplary waveform diagram illustrating a reference bias voltage output from bias voltage generator of FIG. 6, and a control signal, according to an exemplary embodiment of the invention.

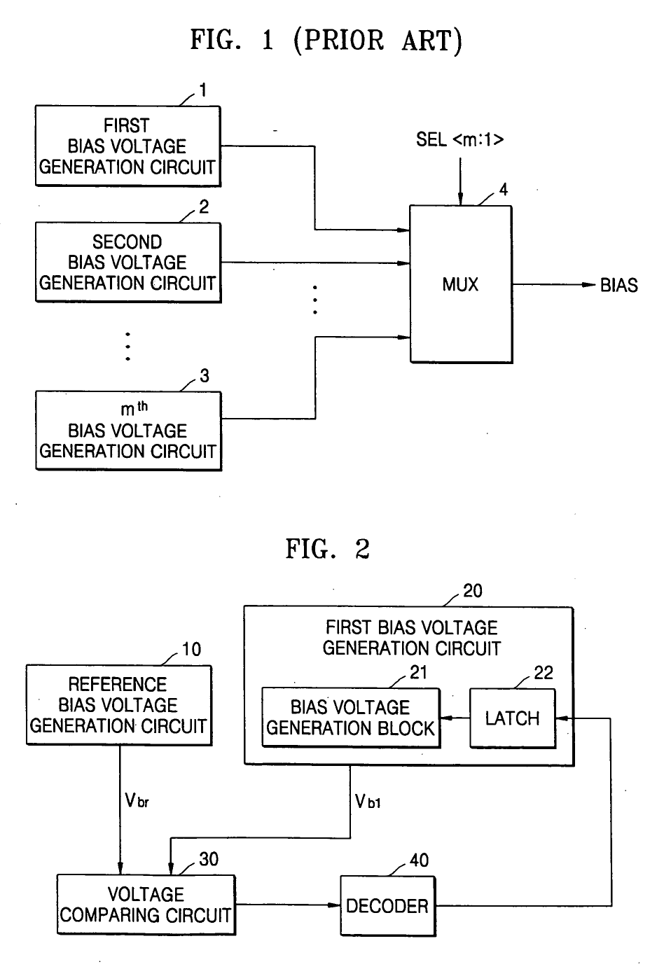

### DETAILED DESCRIPTION OF EXEMPLARY EMBODIMENTS

Hereinafter, exemplary embodiments of the present invention will be described in detail with reference to the accompanying drawings. Like reference numerals denote like elements throughout the drawings.

FIG. 2 is a block diagram illustrating a bias voltage generator according to an exemplary embodiment of the invention. Referring to FIG. 2, the bias voltage generator includes a reference bias voltage generation circuit 10, a first bias voltage generation circuit 20, a voltage comparing circuit 30, and a decoder 40.

A bias voltage generator generally includes a plurality of bias voltage generation circuits, each generating a bias voltage. From among the plurality of bias voltage generation circuits, a bias voltage generation circuit that can generate a stable bias voltage and which is least affected by external conditions such as, operating voltage, power consumption, etc., is selected as a reference bias voltage generation circuit 10. FIG. 2 illustrates only the reference bias voltage generation circuit 10 and a first bias voltage generation circuit 20, but the number of bias voltage generation circuits is not limited.

The first bias voltage generation circuit 20 generates a bias voltage equal to or different from a reference bias voltage Vbr. Even if the first bias voltage generation circuit 20 is designed to generate a first bias voltage Vb1 that is equal to the reference bias voltage Vbr, the first bias voltage Vb1 may be changed due to the above external conditions.

The first bias voltage Vb1 is equalized with a target voltage by using the first bias voltage generation circuit 20 to automatically trim the voltage Vb1 in a power-up/reset period with respect to the reference bias voltage Vbr, thereby compensating for the difference between the target voltage of the first bias voltage Vb1, and an actual output voltage. An exemplary trimming operation will now be described in further detail.

The voltage comparing circuit 30 compares the reference bias voltage Vbr with the first bias voltage Vb1, and outputs a signal corresponding to the difference there between. The decoder 40 receives and decodes the signal received from the voltage comparing circuit 30, and outputs the decoding result. The decoded signal contains trimming information used to trim the first bias voltage Vb1, and the trimming information is stored in a latch unit 22 included in the first bias voltage generation circuit 20.

After the trimming information for the first bias voltage Vb1 is stored, during a normal operation of the semiconductor integrated circuit including the first bias voltage generation circuit 20, the trimming operation is performed to output a trimmed version of the first bias voltage Vb1. During the normal operation of the semiconductor integrated circuit, a bias voltage generation block 21 included in the first bias voltage generation circuit 20 receives the trimming information from the latch unit 22, trims the first bias voltage Vb1 based on the trimming information, and outputs the trimmed version of the first bias voltage Vb1.

Alternatively, a bias voltage generator's latch unit 22 for storing trimming information, according to an exemplary embodiment of the invention, may be comprised of volatile latches. This is because the trimming information for the first bias voltage Vb1 required to be trimmed in each power-up/reset period is automatically generated and stored, so there is no need to store the trimming information, even when the power is off.

When the first bias voltage Vb1 is significantly changed due to a change in an operating voltage region of the first bias voltage generation circuit 20, the trimming information for the first bias voltage Vb1, which corresponds to the changed operating voltage region is stored. The voltage comparing circuit 30 is enabled to store the trimming information corresponding to the changed operating voltage region in the latch unit 22. Therefore, even if the first bias voltage generation circuit 20 has more than one operating voltage region, there is no need to add a latch to store the trimming information.

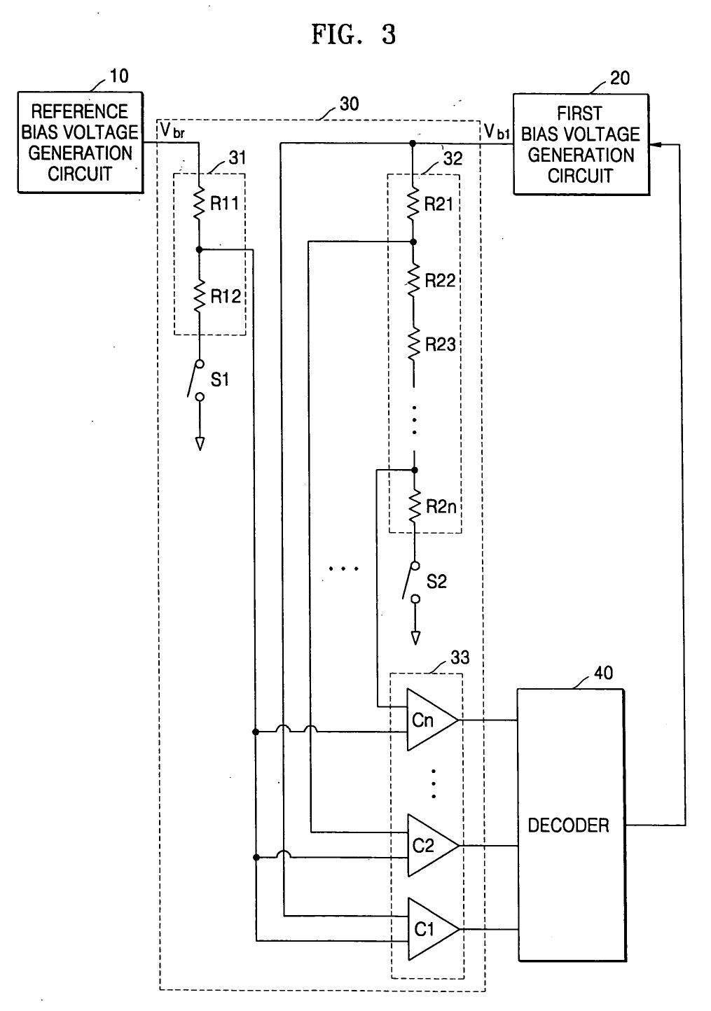

FIG. 3 is a detailed circuit diagram of an exemplary embodiment of the voltage comparing circuit 30 of FIG. 2 according to an exemplary embodiment of the invention. Referring to FIG. 3, the voltage comparing circuit 30 is electrically connected to the reference bias voltage generation circuit 10 and the first bias voltage generation circuit 20 to receive a reference bias voltage and a first bias voltage. The voltage comparing circuit 30 includes a first voltage divider 31, a second voltage divider 32, and a plurality of comparing units 33.

The first voltage divider 31 includes a plurality of resistors R11 and R12, and the reference bias voltage Vbr is divided by the resistors R11 and R12. The second voltage divider 32 includes a plurality of resistors R21 through R2n, and the first bias voltage Vb1 is divided by the resistors R21 through R2n.

The comparing unit 33 is comprised of a plurality of comparators C1 through Cn, which receive voltages obtained by dividing the first bias voltage in the second voltage divider 32, respectively, and a voltage obtained by dividing the reference bias voltage. The comparators C1 through Cn each compare their respective input voltages and output comparison signals. The comparison signals output from the comparing unit 33 are decoded by the decoder 40, and the decoded trimming information is applied to a latch 22 of the first bias voltage generation circuit 20.

In addition, a first enable switch S1 is connected to the first voltage divider 31 so that it can be disabled after generation of the trimming information for the bias voltage, thereby preventing unnecessary trimming information from being generated and reducing power consumption. Similarly, a second enable switch S2 is connected to the second voltage divider 32 so that it can be disabled after generation of the trimming information for the bias voltage.

An exemplary method of generating trimming information will now be described. The voltage obtained by dividing the reference bias voltage is applied to one of the input terminals of each of the comparators C1 through Cn, and the voltages obtained by dividing the first bias voltage are respectively applied to the other input terminal of each of the comparators C1 through Cn. The voltages obtained by dividing the first bias voltage respectively applied to the other input terminals of each of the comparators C1 through Cn are changed by a predetermined voltage. In an exemplary embodiment, if the resistors R21 through R2n of the second voltage divider 32 all have the same resistance value, the voltages obtained by dividing the first bias voltage, which are respectively applied to the other input terminals of the first through nth comparators C1 through Cn, are sequentially reduced by the same voltage.

Each of the comparators C1 through Cn compares the voltage obtained by dividing the reference bias voltage with the divided first bias voltages, and outputs a comparison signal. Each comparator outputs a logic high-level signal when a voltage obtained by dividing the first bias voltage is greater than the voltage obtained by dividing the reference bias voltage, and outputs a logic low-level signal otherwise. The decoder 40 receives and decodes the comparison signals, and outputs trimming information corresponding to the difference between the voltage obtained by dividing the first bias voltage and the voltage obtained by dividing the reference bias voltage.

In an exemplary embodiment where the bias voltage generator includes a plurality of bias voltage generation circuits, the bias voltage generation circuits may share the voltage comparing circuit 30 and the decoder 40 or use different voltage comparing circuits and different decoders so as to generate trimming information. This exemplary embodiment will now be described in further detail.

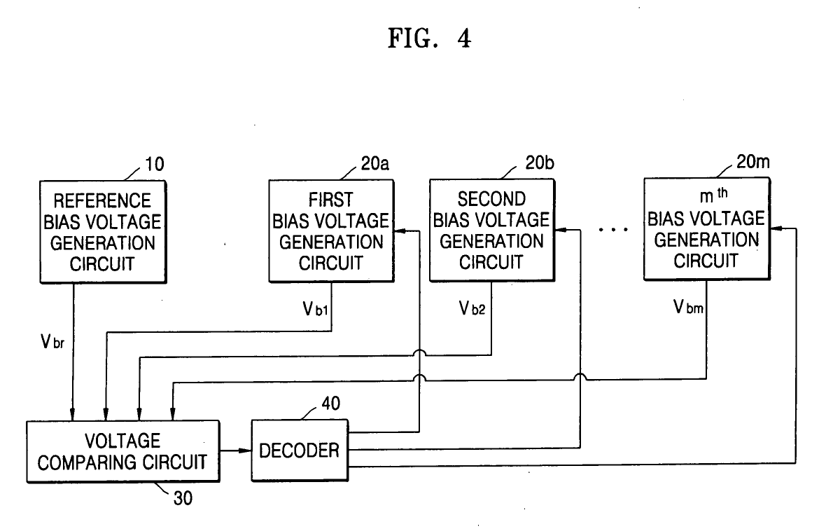

FIG. 4 is a block diagram illustrating a bias voltage generator in which a plurality of bias voltage generation circuits 20a through 20m are connected to a voltage comparing circuit 30 and a decoder 40, according to an exemplary embodiment of the invention. A bias voltage generator according to an exemplary embodiment of the invention may include a reference bias voltage generation circuit 10 and a plurality of bias voltage generation circuits, e.g., m bias voltage generation circuits 20a through 20m illustrated in FIG. 4.

Bias voltages Vb1 through Vbm output from the respective m bias voltage generation circuits 20a through 20m are trimmed with respect to a bias voltage Vbr generated by the reference bias voltage generation circuit 10. To generate trimming information required to trim the bias voltages Vb1 through Vbm output from the respective m bias voltage generation circuits 20a through 20m, the reference bias voltage Vbr is compared with each of the bias voltages Vb1 through Vbm. In an exemplary embodiment, as illustrated in FIG. 4, the m bias voltage generation circuits 20a through 20m share the voltage comparing circuit 30 and the decoder 40.

Specifically, a bias voltage generated by one of the m bias voltage generation circuits 20a through 20m is compared with the reference bias voltage Vbr. For instance, the bias voltage Vb1 generated by the first bias voltage generation circuit 20a is compared with the reference bias voltage Vbr using the voltage comparing circuit 30, and a comparison signal output from the voltage comparing circuit 30 is decoded by the decoder 40 to obtain trimming information. The obtained trimming information is stored in a latch (not shown) of the first bias voltage generation circuit 20a. Similarly, the bias voltage Vb2 generated by the second bias voltage generation circuit 20b is compared with the reference bias voltage to obtain a comparison signal and the comparison signal is decoded. In this way, trimming information for each of the m bias voltage generation circuits 20a through 20m that share the voltage comparing circuit 30 and the decoder 40 is generated and stored.

When a plurality of bias voltage generation circuits are arranged to share a voltage comparing circuit and a decoder as described above, the layout size can be minimized.

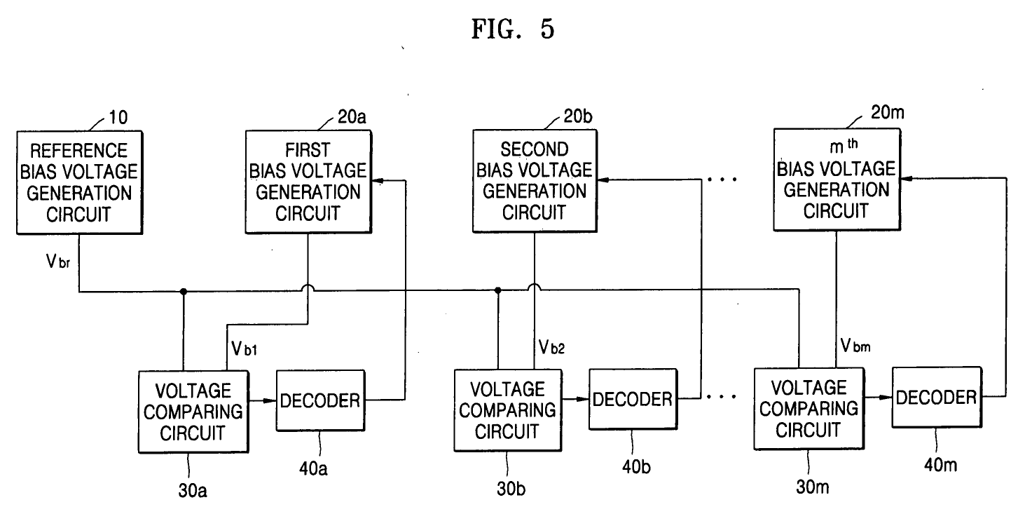

FIG. 5 is a block diagram illustrating a bias voltage generator according to another exemplary embodiment of the invention. Referring to FIG. 5, the bias voltage generator includes a reference bias voltage generation circuit 10, a plurality of bias voltage generation circuits 20a through 20m, a plurality of comparing circuits 30a through 30m, and a plurality of decoders 40a through 40m.

The comparing circuits 30a through 30m compare a reference bias voltage Vbr with bias voltages Vb1 through Vbm output from the respective bias voltage generation circuits 20a through 20m so as to generate trimming information for bias voltages Vb1 through Vbm.

The decoders receive and decode comparison signals output from the respective voltage comparing circuits 30a through 30m to obtain trimming information, and provide the trimming information to a latch (not shown) of each of the respective bias voltage generation circuits 20a through 20m.

Since the reference bias voltage Vbr and the respective bias voltages Vb1 through Vbm output from each of the bias voltage generation circuits 20a through 20m are applied to each of the voltage comparing circuits 30a, 30b, . . . , or 30m, the trimming information for the bias voltages Vb1 through Vbm are simultaneously stored in latches (not shown) of the respective bias voltage generation circuits 20a through 20m.

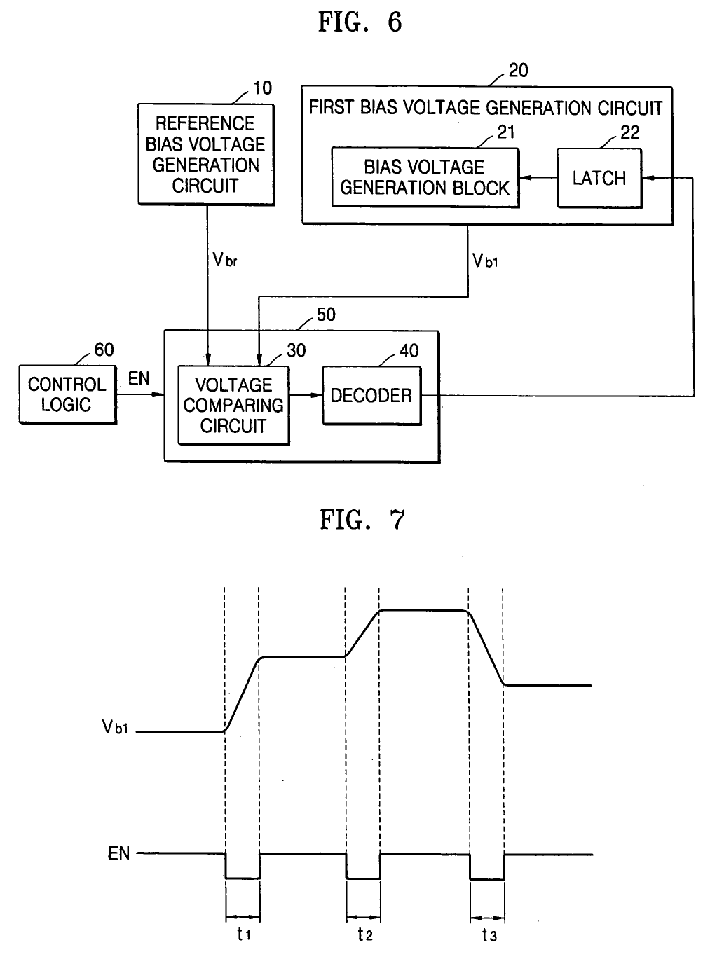

A bias voltage generator according to another exemplary embodiment of the invention will now be described with reference to FIGS. 6 and 7. Since the reference numerals Vbr and Vb1 that appear in FIGS. 6 and 7, denote the same elements that appear in FIG. 2, a description of those reference numerals will not be repeated.

Referring to FIG. 6, the automatic trimming bias voltage generator includes a reference bias voltage generation circuit 10, a first bias voltage generation circuit 20, a trimming information generation circuit 50, and a control logic 60. The trimming information generation circuit 50 includes a voltage comparing circuit 30 and a decoder 40. The number of bias voltage generation circuits is not limited.

The voltage comparing circuit 30 receives and compares a reference bias voltage Vbr and a first bias voltage Vb1, and outputs a comparison signal. The decoder 40 receives and decodes the comparison signal from the voltage comparing circuit 30, and generates trimming information.

In an exemplary embodiment of the invention, the trimming information generation circuit 50 is enabled in regions in which a bias voltage is significantly changed, e.g., a power-up/reset period of a semiconductor integrated circuit, or a region in which an operating voltage is changed. Thus, an enable region in which the trimming information generation circuit 50 is enabled using the control logic 60 is set, and a control signal EN containing information regarding the enable region is input to the trimming information generation circuit 50. Then, trimming information is automatically generated in the enable region, and stored in the bias voltage generation circuit as described above.

FIG. 7 is a waveform diagram illustrating a reference bias voltage and a control signal generated in an exemplary embodiment of the bias voltage generator of FIG. 6 according to an exemplary embodiment of the invention. As illustrated in FIG. 6 and FIG. 7, when the first bias voltage generation circuit 20 has more than one operating voltage region, in regions t1 through t3 in which a bias voltage is suddenly changed, trimming of the bias voltage is performed. The control logic 60 generates a control signal EN, which enables the trimming information generation circuit 50, in the regions t1 through t3 and applies it to the trimming information generation circuit 50. Referring to FIG. 7, the trimming information generation circuit 50 is enabled when the control signal EN is logic low, but may also be enabled when the control signal EN is logic high.

As described above, according to an exemplary embodiment of the invention, a test mode for trimming a bias voltage, and an additional storage device and a high-voltage control circuit are not required, and thus, it is possible to trim the bias voltage in a plurality of operating voltage regions without adding elements to the layout.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A bias voltage generator, comprising:
a reference bias voltage generation circuit generating a reference bias voltage;
a bias voltage generation circuit, that generates a bias voltage which is automatically trimmed using the reference bias voltage as a reference voltage;
a voltage comparing circuit comparing the reference bias voltage with a bias voltage output from a bias voltage generation circuit, and outputting a comparison signal; and
a decoder receiving the comparison signal from the voltage comparing circuit, decoding the comparison signal, and outputting the result of decoding as trimming information for the bias voltage to the bias voltage generation circuit.

2. The bias voltage generator of claim 1, wherein the bias voltage generation circuit comprises a trimming information storage unit storing the trimming information for the bias voltage.

3. The bias voltage generator of claim 2, wherein the trimming information storage unit comprises volatile latches.

4. The bias voltage generator of claim 1, wherein the voltage comparing circuit comprises:
a first voltage divider for dividing the reference bias voltage;
a second voltage divider for dividing the bias voltage output from the bias voltage generation circuit; and
a comparator, that receives a voltage divided by the first voltage divider and a voltage divided by the second voltage divider, compares the received voltages, and outputs a comparison signal.

5. The bias voltage generator of claim 4, wherein the voltage comparing circuit further comprises a first enable switch connected to the first voltage divider to prevent the divided reference bias voltage from being applied to the comparator after outputting the trimming information for the bias voltage.

6. The bias voltage generator of claim 5, wherein the voltage comparing circuit further comprises a second enable switch connected to the second voltage divider to prevent the divided bias voltage from being applied to the comparator after outputting the trimming information for the bias voltage.

7. The bias voltage generator of claim 1, comprising a plurality of bias voltage generation circuits that each output a respective voltage to the voltage comparing circuit, wherein the decoder outputs the trimming information for a bias voltage to a corresponding bias voltage generation circuit.

8. A bias voltage generator, comprising:
a reference bias voltage generation circuit generating a reference voltage;
a plurality of bias voltage generation circuits, each generating a respective bias voltage that is automatically trimmed using the reference bias voltage as a reference voltage;
a plurality of voltage comparing circuits, each comparing the reference bias voltage with a bias voltage output from a corresponding one of the bias voltage generation circuits; and
a plurality of decoders, each receiving and decoding a comparison signal output from a corresponding one of the voltage comparing circuits, and outputting trimming information obtained by decoding the comparison signals to a corresponding bias voltage generation circuit.

9. The bias voltage generator of claim 8, wherein each bias voltage generation circuit comprises a trimming information storage unit storing the trimming information for the bias voltage.

10. The bias voltage generator of claim 9, wherein the trimming information storage unit comprises volatile latches.

11. The bias voltage generator of claim 8, wherein each voltage comparing circuit comprises:
a first voltage divider for dividing the reference bias voltage;
a second voltage divider for dividing the bias voltage output from one of the bias voltage generation circuits; and
a comparator, that receives a voltage obtained by dividing the first voltage divider and a voltage divided by the second voltage divider, compares the received voltages, and outputs a comparison signal.

12. The bias voltage generator of claim 11, wherein each voltage comparing circuit further comprises a first enable switch connected to the first voltage divider to prevent the divided reference bias voltage from being applied to the comparator after outputting the trimming information for the bias voltage.

13. The bias voltage generator of claim 12, wherein each voltage comparing circuit further comprises a second enable switch connected to the second voltage divider to prevent the divided bias voltage from being applied to the comparator after outputting the trimming information for the bias voltage.

14. A bias voltage generator, comprising:
a reference bias voltage generation circuit generating a reference bias voltage;
a bias voltage generation circuit, that generates a bias voltage which is automatically trimmed using the reference bias voltage as a reference voltage;
a trimming information generation circuit receiving the reference bias voltage, and the bias voltage output from the bias voltage generation circuit, and generating trimming information for the bias voltage; and
a control logic generating a control signal containing information regarding a period when the bias voltage is trimmed due to a change in the bias voltage, and enabling the trimming information generation circuit in the period.

15. The bias voltage generator of claim 14, wherein the trimming information generation circuit comprises:
a voltage comparing circuit comparing the reference bias voltage with a bias voltage output from the bias voltage generation circuit; and
a decoder receiving and decoding a comparison signal output from the voltage comparing circuit, and providing the trimming information obtained by decoding the comparison signal to the bias voltage generation circuit.

16. The bias voltage generator of claim 15, wherein the bias voltage generation circuit comprises a trimming information storage unit storing the trimming information for the bias voltage.

17. The bias voltage generator of claim 16, wherein the trimming information storage unit comprises volatile latches.

18. The bias voltage generator of claim 15, wherein the voltage comparing circuit comprises:
a first voltage divider for dividing the reference bias voltage;
a second voltage divider for dividing the bias voltage output from the bias voltage generation circuit; and
a comparator, that receives a voltage divided by the first voltage divider and a voltage divided by the second voltage divider, compares the received voltages, and outputs a comparison signal.

19. The bias voltage generator of claim 18, wherein the voltage comparing circuit further comprises a first enable switch connected to the first voltage divider to prevent the divided reference bias voltage from being applied to the comparator after generating the trimming information for the bias voltage, the first enable switch being enabled in response to the control signal.

20. The bias voltage generator of claim 19, wherein the voltage comparing circuit further comprises a second enable switch connected to the second voltage divider to prevent the divided bias voltage from being applied to the comparator after generating the trimming information for the bias voltage, the second enable switch being enabled in response to the control signal.

21. A method for automatically trimming a bias voltage, comprising:
generating a bias voltage;
comparing the bias voltage to a reference voltage and outputting a comparison signal;
decoding the comparison signal to generate trimming information; and
automatically trimming the bias voltage using the trimming information.

22. The method of claim 21, further comprising temporarily storing the trimming information.

23. The method of claim 21, further comprising generating a control signal to enable or disable said comparing.

24. The method of claim 21, wherein said comparing comprises:
dividing the reference voltage;
dividing the bias voltage; and
comparing the divided reference voltage with the divided bias voltage to generate the comparison signal.
